(19) United States
(12) Patent Application Publication
(10) Pub. No.: US 2017/0357303 A1
(43) Pub. Date: Dec. 14, 2017

(54) METHOD AND DEVICE FOR ENERGY-SAVING EXTERNAL SYNCHRONIZATION OF CLOCKS IN A DISTRIBUTED REAL-TIME COMPUTER SYSTEM

(71) Applicant: FTS Computertechnik GmbH, Wien (AT)

(72) Inventors: Hermann KOPETZ, Baden (AT); Stefan POLEDNA, Klosterneuburg (AT)

(73) Assignee: FTS Computertechnik GmbH, Wien (AT)

(21) Appl. No.: 15/539,509

(22) PCT Filed: Dec. 23, 2015
(86) PCT No.: PCT/AT2015/050329

§ 371 Date: Jun. 23, 2017

(30) Foreign Application Priority Data
Dec. 23, 2014 (AT) A50945/2014

(51) Int. Cl. G06F 1/32; G06F 1/12; G06F 1/14; H04J 3/06

(52) U.S. Cl. CPC G06F 1/324; H04J 3/0638; G06F 1/12; G06F 1/14; H04J 3/0667

(57) ABSTRACT

The present invention relates to a method for synchronizing the clocks of the node computers of a distributed real-time system with an external time reference, such as GPS time, requiring minimal energy expenditure, and for structuring a sparse time-base. By considering the influence of changing physical environmental parameters on the period of oscillation of local oscillators, the holdover interval, according to which an external synchronization must occur, can be dynamically determined and the frequency of the energy-intensive external synchronization processes can be significantly reduced.

The present invention relates to a method for energy-conserving implementation of a global time base in a distributed real-time computer system comprising a plurality of node computers, each node computer having a local clock and having access to an external reference time with the accuracy of an external time measurement A^{ref}.

The present invention also relates to a device for periodically generating a globally synchronized time message.

The present invention additionally relates to a distributed real-time computer system comprising a plurality of node computers, each node computer having a local clock and having access to an external reference time with the accuracy of an external time measurement A^{ref}.

The present invention belongs to the field of computer technology. Described herein is an innovative method by which, in a distributed time-triggered real-time system, the clocks of the node computers can be synchronized with little energy expenditure to an external time reference.

In many technical methods, measured variables that change over time are collected. Measurement of a measured variable that changes over time is only complete if, in addition to the measured variable, the point in time at which the data was collected can be interpreted system-wide. In a distributed computer system in which a plurality of node computers collect the measurement values, therefore, the local clocks of the node computers must be regularly synchronized in order to have a system-wide, global time base of required granularity.

In many technical usages, wireless sensors that draw energy from a battery are used. Battery-powered devices necessitate the use of energy-conserving techniques in order to lengthen the life of a battery. The present invention discloses an innovative method for energy-conserving external synchronization of the clocks of a distributed real-time system.

The granularity of a digital time base determines how much time goes by between two consecutive ticks of the global time. The time granule is a term used to refer to the interval between two consecutive ticks of a digital clock. Since it is not, in principle, possible to completely synchronize the ticks of two autonomous clocks, the time stamps of a single event that is observed by two independent clocks may differ by one tick. In order to ensure that the time stamps of a single event that is observed by any two clocks of a synchronized clock ensemble only ever differ by, at most, one tick, the reasonableness condition [4, p. 58] must be met. The reasonableness condition states that the granularity of the global time base must be greater than the precision of the clocks. The precision of a clock ensemble corresponds to the longest time interval during which all of the corresponding ticks of a clock ensemble take place [4, p. 55].

A distinction is made between the internal and external synchronization of an ensemble of clocks. With internal synchronization, the clocks synchronize with one another. With external synchronization, each clock of the ensemble synchronizes to an external reference time, independently of any other clock. One example of an external reference time is the time that is distributed world-wide by a satellite navigation system, e.g., GPS [1-3].

The present invention addresses the external synchronization of the clocks of a distributed real-time computer system.

The quality of an external synchronization is determined by the setting forth of the accuracy A. The accuracy A sets forth which maximum time interval may elapse between a tick of the external reference time and the corresponding tick of the externally synchronized clock. If two clocks of an ensemble are synchronized with an accuracy A to the reference time, then the precision of these two clocks is 2A [4, p. 55], because—in the extreme case—the local time progresses faster than the reference time by A sec in one clock and slower by A sec in the other clock.

The required granularity of the global time in a distributed real-time system is determined by the dynamics of the technical processes to be observed and controlled, and is to be predetermined as a part of the system analysis.

The predetermined granularity of the global time, the inaccuracy of the reference time collection, and the stability of the oscillator of the local clock determine how often a clock must be synchronized with the external time reference. In this context, the concept of the holdover interval (HOI) is of particular importance. The HOI sets forth how long a local clock can run freely, i.e., without synchronization, before the reasonableness condition [4, p. 58] is violated.

The local clock must be synchronized with the external time reference no later than at the end of the HOI, in order to comply with the reasonableness condition. Whereas the power consumption of a free-running clock is very low, relatively high energy must be expended in order to synchronize to the external reference time, e.g., the GPS time [1-3].

The present invention addresses the problem of holding the HOI as long as possible, so that it is only seldom necessary to synchronize to the external time reference. Dynamically determining the length of the HOI on the basis of a periodic monitoring of the environmental conditions of the oscillator achieves the aim of conserving energy.

This problem is solved with an above-mentioned method and an above-mentioned distributed real-time system in that, according to the present invention, starting from a required granularity G^{glo} of the global time base and the given specified granularity g^{spec} of the local clock of a node computer, a maximum offset interval O^{max} of the tick of the local clock of the node computer with respect to the corresponding tick of the global time to the end time point of a holdover interval HOI is determined according to

O^{max}=(f^{s}·G^{glo}/2−A^{ref}−2g^{spec})

wherein f^{s} is a safety factor, and wherein, next, in an initialization phase with a specified worst-case drift rate DR^{wc} according to

HOI=O^{max}/DR^{wc}

a first HOI with

N^{pl}=HOI/g^{spec}

the number of planned ticks N^{pl} of the local clock and with the initial granularity

g^{vor}=g^{spez}

in the first HOI is determined, and wherein the start time point t^{B} of the first HOI on the external time base is measured, and wherein, next, cyclically at the end of an HOI, the end time point t^{E} of the just-elapsed HOI on the external time base is measured, wherein the end time point t^{E} of an HOI simultaneously represents the start time point t^{B} of the following HOI, and where, during the HOI, the number of the ticks N^{gez} of the local clock is counted, and wherein, after the end of an HOI, the mean granularity g^{d} of the local clock in the immediately-prior HOI is determined according to

g^{d}=(t^{E}−t^{B})/N^{gez}

wherein N^{gez} sets forth the counted number of the ticks in the immediately prior HOI, and wherein this mean granularity is set as an initial granularity of the current HOI, and wherein the number of the initially planned ticks NP¹ of the local clock in the current HOI is determined according to

N^{pl}=O^{max}/(g^{d}−g^{vor})

wherein g^{vor} sets forth the initial granularity of the immediately-prior HOI, and where the initially planned length of the HOI is determined according to

HOI=N^{pl}·g^{d}

and wherein environment parameters of the local clock are periodically measured during the HOI, and—in the event of a change in an environment parameter relative to the start of the HOI—a change in the drift rate DR^{Δ} is determined with the use of the corresponding drift rate change function DRAF and a current granularity g of the local clock is established according to

g=g^{d}(1+DR^{Δ})

and wherein the updated length of the current HOI is determined by means of

HOI^{akt}=min{HOI,[O^{max}/(|DR^{Δ}|],HOI^{st}}

where HOI^{st} sets forth the length of the HOI that arises from the stochastic drift rate, and
where a new cycle is started at the end of the current HOI.

Advantageous embodiments of the method according to the present invention and the distributed real-time system according to the present invention, which may be realized alone or in any combination, are cited as follows:
the number of the ticks N^{glo} of the local clock within a tick of the global time is determined according to N^{go}=G^{glo}/g wherein G^{glo} sets forth the duration of a global tick and g sets forth the current value of the granularity of the local clock;
a period P for measuring the environment parameters is determined according to P=O^{max}/DR^{wc}, wherein DR^{wc} sets forth the specified worst-case drift rate of the oscillator;
in the event of failure to measure the reference time at the end of an HOI, the periodic adjustment of the granularity of the local clock is continued due to change in environment parameters until an external reference time measurement can be performed again;
a sparse time base is constructed with the global time base;
after the end of an HOI, the current global time and/or the measured environment parameters of the oscillator and/or the used granularities of the local clock and/or the different drift rates DR during the HOI are stored in an environmental data bank;
the parameters of the drift rate change function DRAF are adapted to the oscillator used in a node computer, preferably by assessment of the data saved in the environmental data bank.

The present invention also relates to an aforementioned device for periodically generating a globally synchronized time message, wherein the device comprises a microcomputer having a CPU and a storage unit, a receiver for an external reference time signal, a quartz oscillator, a communication interface for sending messages, and a temperature sensor for measuring the temperature of the quartz oscillator, and wherein the device is furnished in order to carry out a method described above for realizing a global time base.

Advantageous embodiments of the device according to the present invention, which may be realized alone or in any combination, are described as follows:
the device has at least one sensor for measuring the air pressure;
the device has at least one sensor for measuring the air humidity;
the device has at least one sensor for measuring the acceleration;
the device has at least one GPS receiver;
the device has at least one GLONAS receiver;
the device has at least one GALILEO receiver;
the device has at least one receiver for an eLORAN time signal;
the device has at least one receiver for a DCF77 time signal;
the device is configured as one structural unit, preferably a compact one;
the microcomputer is furnished for calculating a periodic time signal.

The aforementioned problem is also solved with a distributed real-time computer system comprising a plurality of node computers, each node computer having a local clock and having access to an external reference time with the accuracy of an external time measurement A^{ref}, and the distributed real-time computer system being furnished in order carry out an aforementioned method for energy-conserving realization of a global time base.

Preferably, the real-time computer system has one or more above-described devices.

In particular, it may be provided that one or more of the above-described devices is arranged after every in nodes of the real-time computer system, in particular, exactly one device in each node.

If a digital global time is present with a defined granularity in a distributed computer system, wherein the reasonableness condition is always met, then a sparse time base can be constructed in the system [4, p. 64]. A sparse time base differentiates between active and passive time granules, and limits the occurrence of events to the active time granules. In a sparse time base, all events that occur within an active time granule are classified as being simultaneous, and events that occur in two different active time granules are ordered in a manner consistent with time system-wide. If the events are triggered by a computer node, e.g., the start of transmission of a message, then at least three passive time granules are to be provided in a sparse time base between two active granules that globally have the same identification. If an external event occurs in a passive interval of the sparse time, then it is to be associated with an active interval by means of an agreement protocol [4, p. 63]. The sparse time base prevents inconsistencies in the temporal ordering of events. Inconsistencies in the temporal ordering may lead to sporadic errors in the system overall.

The present invention discloses a method for synchronizing the clocks of the node computers of a distributed real-time system with an external time reference, such as GPS time, requiring minimal energy expenditure, and for structuring a sparse time base. By considering the influence of changing physical environmental parameters on the period of oscillation of local oscillators, the holdover interval, according to which an external synchronization must occur, can be dynamically determined and the frequency of the energy-intensive external synchronization processes can be significantly reduced.

The present invention is described in greater detail hereinbelow with reference to the drawings. In the drawings,

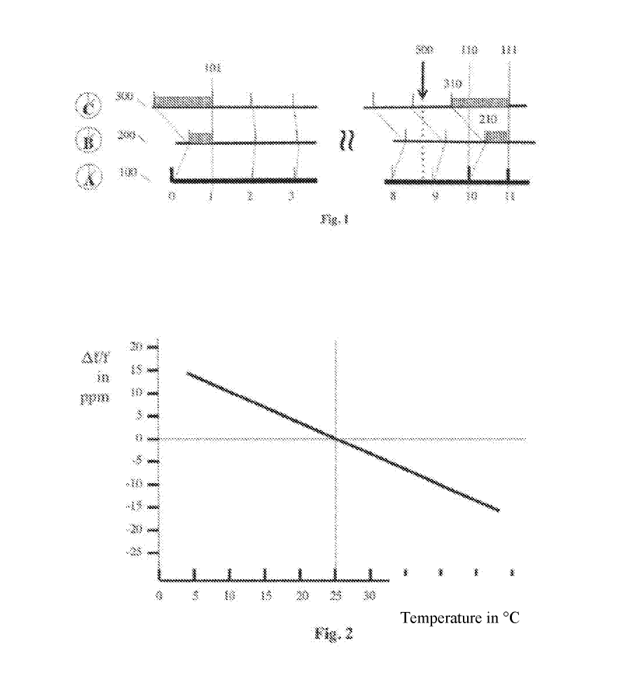

FIG. 1 illustrates the behavior of clocks on a timeline; and

FIG. 2 illustrates an example of a drift rat change function (DRCF) when there is a change in temperature.

One possible implementation of the present invention shall be explained with reference to the aforementioned drawings. Therein, the abbreviations shown in the following Tablel are used.

TABLE 1
Abbreviations used

| Symbol | Dim | Explanation |
|---|---|---|
| A^{ref} | [sec] | accuracy error (accuracy) of the external time |
| | | measurement |
| DR | none | drift rate of the oscillator |
| DRAF | none | drift rate change function |
| DR^{next} | none | drift rate of the oscillator in the next HOI |
| DR^{st} | none | stochastic drift rate of the oscillator |
| DR^{wc} | none | worse case drift rate of the oscillator, according |
| | | to the specification |
| DR^{Δ} | none | change in the drift rate due to change in |
| | | environmental parameter(s) |
| f^{s} | none | safety factor of the required granularity of the |
| | | global time base |
| g | [sec] | granularity of the local clock |
| g^{akt} | [sec] | current granularity of the local clock |
| g^{d} | [sec] | mean granularity of the local clock in the immediately |
| | | prior HOI |
| G^{glo} | [sec] | required granularity of the global time base, global |
| | | time granule |
| g^{spec} | [sec] | specified granularity of the local clock |
| g^{vor} | [sec] | initial granularity of the local clock |
| HOI | [sec] | holdover interval |
| HOI^{akt} | [sec] | current holdover interval |
| HOI^{st} | [sec] | longest holdover interval based on the stochastic |
| | | drift rate |
| N^{gez} | none | counted number of ticks in the immediately-prior HOI |
| N^{glo} | none | number of ticks of the local clock in a global time |
| | | granule G^{glo} |
| N^{pl} | none | number of planned ticks N^{pl} of the local clock in the HOI |
| O^{max} | [sec] | maximum offset of the global time at the end of the HOI |
| P | [sec] | period P for measuring the environment parameters of a |
| | | local clock |
| t^{B} | [sec] | point in time when the HOI starts, as measured with the |
| | | external time reference |
| t^{E} | [sec] | point in time when the HOI ends, as measured with the |
| | | external time reference |

On the timeline 100 according to FIG. 1, the progression of the global external reference time, as offered by an external time reference system, e.g., the GPS system, is set forth from left to right. The ticks 0, 1, 2, 3 . . . 8, 9, 10, 11 of the clock A that are plotted on the abscissa 100 mark the ticks of the global time. On the timeline 100, the distance between two consecutive ticks, e.g., between the tick 1 and the tick 2, corresponds exactly to the required global granularity G^{glo} of the global time, as expressed in seconds. This global granularity may be captured with a very accurate reference clock, e.g., an atomic clock.

Capturing the length of an interval with a digital reference clock with the granularity g requires that the time stamp of the start time point t^{B} of the interval and the time stamp of the end time point t^{E} of the interval are formed. The time stamp of an event is understood to mean the state of the reference clock at or immediately after the occurrence of the event. The length of the interval is then given by (t^{E}−t^{B})±g. If the start time point and the end time point of different clocks of a globally synchronized ensemble are captured, wherein the plausibility condition is met, then the length of the interval is given by (t^{E}−t^{B})±2g [see 4, p. 61-62].

In the local view of the global ticks 0 and 10, the local clocks B and C of the ensemble synchronize to the external reference time of the clock A so as to be again synchronized with the reference time at tick 1 101 and at tick 11 111.

FIG. 1 shows the sequence of the global ticks of three clocks, the reference clock A on the timeline 100, the local clock B on the timeline 200, and the local clock C on the timeline 300.

In a real, physical system, an error of less than Ara seconds—the accuracy error of the external time measurement—may occur between the synchronization events, e.g., to the external reference time point 101 or 111 on the timelines 200 and 300. This accuracy error A^{ref} arises, inter alia, from the different run times and processing times of the time signals of the reference time, and is set forth in the data sheet of the time receiver. With a typical GPS receiver, the accuracy error A^{ref} of the external time measurement is less than 100 nsec. FIG. 1 does not depict this accuracy error A^{ref}.

In FIG. 1, it is assumed that the clock B and the clock C synchronize again to the external time after 10 global ticks. Between the global tick 1 and the global tick 10 of FIG. 1, the two local clocks B and C are free running, i.e., autonomously count the number of vibrations of the local physical oscillation circuit thereof.

An external event, e.g., the event 500 in FIG. 1, is given the time stamp 8 by the clock A and the time stamp 8 by the clock B, but the time stamp 9 by the clock C. If the occurrence of external events is not limited, this inconsistency in principle cannot be avoided. Introducing a sparse time that limits the occurrence of external events to the active intervals of the sparse time solves the problem of the temporal inconsistency (see the detailed approach to the sparse time in [4, p. 58-65]).

The behavior of the local clock B is set forth on the timeline 200. The clock derives the perception of time thereof from the oscillation of the local quartz oscillator. The ticks of the timeline 200 0, 1, 2, 3 . . . 8, 9, 10, 11 mark the global ticks from the view of this local clock. The duration of one oscillation of the local quartz oscillator is called the local granularity g of the oscillator. Since the duration of one oscillation of the oscillator of the clock B is slightly longer than specified, the clock B reaches the synchronization point 210 later than the external reference clock A, which has already reached the tenth tick at the time point 110. At the time point 210, the clock B reads the global time of the external reference clock and determines that it is already in the time granule <10,11>. It will shorten the local time granule <10,11> to the length <210,111>, so as to be synchronized with the tick 11 of the reference clock A at tick 11.

The behavior of the local clock C is set forth analogously on the timeline 300. The ticks 0, 1, 2, 3 . . . 8, 9, 10, 11 on the timeline 300 mark the global ticks of this local clock C. Since the duration of one oscillation of the oscillator of the clock C is slightly shorter than specified, the clock C reaches the synchronization point 310 thereof earlier than the external reference clock A, which will only reach the tenth tick thereof at the time point 110. At the time point 310, the clock C reads the global time of the external reference clock and determines that it is still in the time granule <9,11> of the reference clock. It will shorten the local time granule <10,11> to the length <310,111>, so as to be synchronized with the tick 11 of the reference clock A at tick 11.

The synchronization of the clock B and the dynamic determination of the HOI (holdover intervals) shall be described in an exact manner hereinbelow. Since, in the external synchronization, the clock of every node computer synchronizes to the global external reference time—represented on the timeline 100—independently of the clock of every other node computer, the operation of the computer node B as described herein is performed by all of the other computer nodes of the ensemble, i.e., also by the computer node C.

The clock B must again take on the external reference time of the clock A before it deviates by more than the maximum offset O^{max}

O^{max}=(f^{s}·G^{glo}/2−A^{ref}−2g^{spec})

seconds from the corresponding tick of the clock A. The factor f^{g} is a safety factor that is between 0.5 and 1, and is typically set to 0.8. The term 2 g^{spec} the specified granularity of the clock B, takes into consideration the digitization error in the time measurement [4, p. 61] of the external reference time.

In the example, it is assumed that the clock B contains a quartz oscillator as the oscillation circuit [5]. The duration of one oscillation of the quartz oscillator is determined primarily by the mechanical dimensions of the quartz crystal, and secondarily by the physical environmental conditions of the crystal, such as temperature, air pressure, air humidity, acceleration, electric excitation, and the like [6]. The data sheet of a quartz oscillator makes available the specified granularity of the local clock g^{spec}, i.e., the nominal duration of one oscillation, and the deviations in this granularity, as expressed in the worst-case drift rate DR^{wc} of the oscillator within the intended area of use. Typical values for DR^{wc} are between 10⁻³ and 10⁻⁸ seconds/second.

In the initialization phase, immediately after the clock synchronization is switched on, the start time point t^{B} of the first HOI is time-stamped with the external reference time, and the length of the first HOI is calculated with the use of the specified worst-case drift rate DR^{wc} of the local clock according to

HOI=O^{max}/DR^{wc}

FIG. 1 represents the length of the HOI through the interval between the tick 1 and the tick 11 of the external reference time A on the timeline 100.

Then,

N^{pl}=HOI/g_{spec}

provides the equation according to which the number of planned ticks N^{pl} of the local clock in the first HOT is determined. The granularity g^{spez} of the local clock that is specified in the data sheet is taken as the initial granularity g^{vor}

g^{vor}=g^{spez}

in the first HOI. This completes the initialization.

The following actions for dynamically calculating the additional HOIs are iterated cyclically.

At the end of an HOI, the end time point t^{E} of the just-elapsed HOI is time-stamped with the external time on the axis 100 of FIG. 1. The end time point t^{E} of an HOI is simultaneously the start time point t^{B} of the following HOI. During the HOI, the number of ticks N^{gez} of the local clock is counted. After the end of an HOI, the mean granularity g^{d} of the local clock in the immediately prior HOI is determined by means of

g^{d}=(t^{E}−t^{B})/N^{gez}

wherein N^{gez} sets forth the counted number of ticks in the immediately prior HOI. This mean granularity g^{d} of the immediately prior HOI is used as the initial granularity of the current HOI. By means of

N^{pl}=O^{max}/(g^{d}−g^{vor})

the number of the initially planned ticks N^{pl} of the local clock in the current HOI is determined, wherein g^{vor} sets forth the initial granularity of the immediately preceding HOI and where g^{d} sets forth the mean measured granularity of the immediately prior HOI. The initially planned length of the running HOI is determined according to

HOI=N^{pl}·g^{d}

The granularity g of the local clock B may change during the HOI, due to a change in an environment parameter, e.g., temperature, air pressure, air humidity, acceleration, or the like. Since the environment parameters can be periodically captured with low-cost micro-electro-mechanical system (MEMS) sensors, the granularity of the local clock B is, according to the present invention, periodically adapted to the changed environment parameters.

The environment parameters of the local clock, e.g., temperature, air pressure, air humidity, and/or acceleration, are measured periodically during the current HOI. The period P for measuring the environment parameters is determined according to

P=O^{max}/DR^{wc}

wherein DR^{wc} represents the specified worst-case drift rate of the oscillator.

If there is determined to be change in an environment parameter relative to the value at the start of the HOI, then the change in the drift rate DR^{Δ}, relative to the start of the HOI, is determined with the use of the corresponding drift rate change function DRAF (see FIG. 2).

The drift rate change function DRAF gives the dependence of the drift rate change on a change in an environment parameter. Preferably, a drift rate change function DRAF is known for every environment parameter that is measured. An example of a DRAF is represented in FIG. 2. In FIG. 2, the specified granularity of the local clock g^{spec} applies at 25° C. If the ambient temperature of 25° C. rises to 40° C., then—according to the DRAF in FIG. 2—the relative frequency change is −10.10⁻⁶ sec/sec and the relative oscillation duration change is +10.10⁻⁶ sec/sec. The temperature dependence of a quartz oscillator is very highly dependent on the situation of the crystallographic axis in the oscillator [5, p. 13]. Compared to the temperature, the other environment parameters, such as air pressure, air humidity, acceleration, and the like have a lower impact on the drift rate [6]. The drift rate change functions DRAF of the used quartz oscillator must be either taken from the literature (e.g. [5, 6]) or determined experimentally.

By means of g=g^{d} (1+DR^{Δ})

a new current granularity g of the local clock is calculated from the mean granularity g^{d} of the local clock in the immediately prior HOI and the drift rate change DR^{Δ}.

When there is a change in drift rate DR^{Δ}, the value of the current HOI^{akt} is also determined anew according to

HOI^{akt}=min{HOI,[O^{max}/(|DR^{Δ}|],HOI^{st}}

The term HOI^{st} sets forth the maximum length of the HOI, which can be derived from the stochastic drift rate DR^{st} according to HOI^{st}=O^{max}/DR^{st}.

The concrete value of the stochastic drift rates depends on the accuracy and the frequency of measurement of the environment parameters [6], and must be determined within the context of the system analysis. The range of values for DR^{st} is between 10⁻⁵ and 10⁻¹². In the following example (table 2), a value of 10⁻⁶ is assumed.

If the granularity g of the local clock is always changing, the number of ticks of the local clock in the global time granule G^{glo} must be determined anew according to

N^{glo}=G^{glo}/g

During the operation of the node computer B, the captured functional dependence between the environment parameters observed in operation and the drift rate is saved in an environmental data bank. The assessment of this environmental data bank with methods of big data analytics leads to adaption of the drift rate change functions DRAF to the quartz oscillator used in the node computer B.

One or more of the following time signal sources may be used as an external time reference.
The GPS signal
The GLONASS signal
The GALILEO signal
The longwave time signal DCF77
The longwave time signal e-LORAN

The described synchronization method can be realized with a device that comprises a microcomputer having a CPU and storage unit, a receiver for an external reference time signal, a quartz oscillator, a communication interface for wirelessly transmitting messages, and environmental sensors for measuring the environmental conditions of the quartz oscillator. The device may contain, as environmental sensors, a sensor for capturing the temperature and/or a sensor for measuring the air pressure and/or a sensor for measuring the air humidity and/or a sensor for measuring the acceleration.

Such a device may be used as a compact PTP Grandmaster Clock, according to the IEEE 1588 Clock Synchronization Standard. The device may also contain a receiver for a plurality of the aforementioned external reference time signals, in order to be able to tolerate the failure of a signal.

Table 2 shows a concrete example of how the holdover interval HOI may change during the operation of a computer node.

The example shows that the distance between two synchronization time points is substantially increased by the dynamic determination of the HOIs (cf. lines 9 and 20), and, as a result, the number of the synchronization events and the associated energy expenditure for the synchronization are significantly reduced. The change in the ambient temperature of the local clock from 25° C. to 40° C. leads to such a substantial change in the drift rate of the local time that the HOI must be shortened.

TABLE 2
Example for the calculation of the HOI

| | Abr | Data source | Example | |
|---|---|---|---|---|
| 1 | G^{glo} | System specification | 100 | μsec |
| 2 | f^{s} | Presumption of safety | 0.8 | |
| 3 | A^{ref} | GPS receiver | 50 | nsec |
| 4 | g^{spec} | g^{spec} from the oscillator data | 0.1 | μsec |
| | | sheet | | |
| 5 | g^{vor} | g^{spec} | 0.1 | μsec |
| 6 | \|DR^{wc}\| | Oscillator data sheet | 0.0005 | |
| 7 | \|DR^{st}\| | Measurement of the | 0.000001 | |
| | | environmental parameters | | |
| 8 | O^{max} | (f^{s} · G^{glo}/2 − A^{ref} − 2 g^{spec}) | 39.750 | μsec |
| 9 | HOI | O^{max}/DR^{wc} | 79 500 | μsec |
| 10 | N^{pl} | HOI/g^{spec} | 795000 | |
| 11 | t^{E} − t^{B} | Reference time measurement | 79508 | μsec |
| 12 | N^{gez} | Measurement | 795002 | |
| 13 | g^{d} | (t^{E} − t^{B})/N^{gez} | 0.100009811 | μsec |
| 14 | N^{pl} | O^{max}/(g^{d} − g^{vor}) | 4 051 575 | |
| 15 | HOI | N^{pl} · g^{d} | 405197 | μsec |
| 16 | t^{E} − t^{B} | Reference time measurement | 405194 | μsec |
| 17 | N^{gez} | Measurement | 4 051 574 | |
| 18 | g^{d} | (t^{E} − t^{B})/N^{gez} | 0.100009034 | μsec |
| 19 | N^{pl} | O^{max}/(g^{d} − g^{vor}) | 51 125 402 | |
| 20 | HOI | N^{pl} · g^{d} | 5 113 018 | μsec |
| 21 | DR^{Δ} | Temperature measurement | 0.00001 | |
| | | 40° C. | | |
| 22 | P | O^{max}/DR^{wc} | 79 500 | μsec |
| 23 | | g^{d} (1 + DR^{Δ}) | 0.1000105 | μsec |
| 24 | HOI^{st} | [O^{max}/(\|DR^{st}\|] | 39 7500 000 | μsec |
| 25 | HOI^{akt} | min{HOI, [O^{max}/(\|DR^{Δ}\|], HOI^{st}} | 3 975 000 | μsec |

### CITED LITERATURE

[1] U.S. Pat. No. 5,864,315
[2] U.S. Pat. No. 7,535,417 B2
[3] US 2012/0146850 A1
[4] Kopetz, H. Real-Time Systems, Design Principles for Distributed Embedded Applications. Springer Verlag. 2011.
[5] Shmaliy, Y. et al. Efficient Predictive Estimator for Holdover in GPS-based clock synchronization. IEEE Trans. on Ultrasonics, Ferroelectrics and Frequency Control. Vol 55. No. 10. pp. 2131-2139. 2008.
[5] Vig, J. R. Introduction to Quartz Frequency Standards. Report SLCET-TR-92-1 US Army Laboratory Command Fort Monmouth, N.J. USA
[6] Walls, F. L. Fundamental Limits on the Frequency Stability of Quartz Oscillator. IEEE Trans. on Ultrasonics, Ferroelectrics and Frequency Control. Vol 42. No. 4. pp. 576-589. 1995.

1. A method for energy-conserving implementation of a global time base in a distributed real-time computer system comprising a plurality of node computers, each node computer having a local clock and having access to an external reference time with the accuracy of an external time measurement A^{ref}, wherein:
starting from a required granularity G^{glo} of the global time base and the given specified granularity g^{spec} of the local clock of a node computer, a maximum offset interval O^{max} of the tick of the local clock of the node computer with respect to the corresponding tick of the global time to the end time point of a holdover interval HOI is determined according to
O^{max}=(f^{s}·G^{glo}/2−A^{ref}−2g^{spec})
wherein f^{s} is a safety factor, and wherein, next, in an initialization phase with a specified worst-case drift rate DR^{wc} according to
HOI=O^{max}/DR^{wc}
a first HOI with
N^{pl}=HOI/g^{spec}
the number of planned ticks N^{pl} of the local clock and with the initial granularity
g^{vor}=g^{spez}
in the first HOI is determined, and wherein the start time point t^{B} of the first HOI on the external time base is measured, and wherein, next, cyclically at the end of an HOI, the end time point t^{E} of the just-elapsed HOI on the external time base is measured, wherein the end time point t^{E} of an HOI simultaneously represents the start time point t^{B} of the following HOI, and where, during the HOI, the number of the ticks N^{gez} of the local clock is counted, and wherein, after the end of an HOI, the mean granularity g^{d} of the local clock in the immediately-prior HOI is determined according to
g^{d}=(t^{E}−t^{B})/N^{gez}
wherein N^{gez} sets forth the counted number of the ticks in the immediately-prior HOI, and wherein this mean granularity is set as an initial granularity of the current HOI, and wherein the number of the initially planned ticks N^{pl} of the local clock in the current HOI is determined according to
N^{pl}=O^{max}/(g^{d}−g^{vor})
wherein g^{vor} sets forth the initial granularity of the immediately-prior HOI, and where the initially planned length of the HOI is determined according to
HOI=N^{pl}·g^{d}
and wherein environment parameters of the local clock are periodically measured during the HOI, and—in the event of a change in an environment parameter relative to the start of the HOI—a change in the drift rate DR^{Δ} is determined with the use of the corresponding drift rate change function DRAF and a current granularity g of the local clock is established according to
g=g^{d}(1+DR^{Δ})
and wherein the updated length of the current HOI is determined by means of
HOI^{akt}=min{HOI,[O^{max}/(|DR^{Δ}|],HOI^{st}}
where HOI^{st} sets forth the length of the HOI that arises from the stochastic drift rate, and where a new cycle is started at the end of the current HOI.

2. The method of claim 1, wherein the number of the ticks N^{glo} of the local clock within one tick of the global time is determined according to
N^{glo}=G^{glo}/g
wherein G^{glo} sets forth the duration of a global tick and g sets forth the current value of the granularity of the local clock.

3. The method of claim 1, wherein a period P for measuring the environment parameters is determined according to
P=O^{max}/DR^{wc}
wherein DR^{wc} represents the specified worst-case drift rate of the oscillator.

4. The method of claim 1, wherein in the event of failure to measure the reference time at the end of an HOI, the periodic adjustment of the granularity of the local clock is continued due to change in environment parameters until an external reference time measurement can be performed again.

5. The method of claim 1, wherein a sparse time base is constructed with the global time base.

6. The method of claim 1, wherein after the end of an HOI, the current global time and/or the measured environment parameters of the oscillator and/or the used granularities of the local clock and/or the different drift rates DR during the HOI are stored in an environmental data bank.

7. The method of claim 1, wherein the parameters of the drift rate change function DRAF are adapted to the oscillator used in a node computer, preferably by assessment of the data saved in the environmental data bank.

8. A device for periodically generating a globally synchronized time message, comprising:
a microcomputer having a CPU and a storage unit,
a receiver for an external reference time signal,
a quartz oscillator,
a communication interface for sending messages, and
a temperature sensor for measuring the temperature of the quartz oscillator,
wherein the device is configured to carry out the method of claim 1 for realizing a global time base.

9. The device of claim 8 further comprising at least one sensor for measuring air pressure.

10. The device of claim 8, further comprising at least one sensor for measuring air humidity.

11. The device of claim 8, further comprising at least one sensor for measuring acceleration.

12. The device of claim 8, further comprising at least one GPS receiver.

13. The device of claim 8, further comprising at least one GLONAS receiver.

14. The device of claim 8, further comprising at least one GALILEO receiver.

15. The device of claim 8, further comprising at least one receiver for an eLORAN time signal.

16. The device of claim 8, further comprising at least one receiver for a DCF77 time signal.

17. The device of claim 8, which is configured as one structural unit.

18. The device of claim 8, wherein the microcomputer is configured to calculate a periodic time signal.

19. A distributed real-time computer system comprising:
a plurality of node computers, each node computer having a local clock and having access to an external reference time with the accuracy of an external time measurement A^{ref},
wherein the distributed real-time computer system is configured to carry out the method of claim 1 for energy-conserving realization of a global time base.

20. The distributed real-time computer system of claim 19, which comprises one or more devices for periodically generating a globally synchronized time message, wherein each of the one or more devices comprises:
a microcomputer having a CPU and a storage unit,
a receiver for an external reference time signal,
a quartz oscillator,
a communication interface for sending messages, and
a temperature sensor for measuring the temperature of the quartz oscillator.

21. The distributed real-time computer system of claim 20, wherein one or more of the devices is arranged in each of the nodes of the real-time computer system.
